(19) United States
(12) Patent Application Publication
(10) Pub. No.: US 2005/0247827 A1
(43) Pub. Date: Nov. 10, 2005

(54) Conduit securement clip

(76) Inventor: David Moher, Fort Thomas, KY (US)

Correspondence Address: DONALD N. HALGREN, 35 CENTRAL STREET, MANCHESTER, MA, 01944, US

(21) Appl. No.: 10/832,980

(22) Filed: Apr. 27, 2004

(51) Int. Cl. F16L 3/00; E21F 17/02

(52) U.S. Cl. 248/60

(57) ABSTRACT

A securement clip device for adjustably securing a first diameter conduit and a second diameter conduit to one another in a parallel, spaced-apart, vibration free relationship. The devices comprises a web of material formed into a first diameter conduit enclosing enclosure and a second diameter conduit enclosing enclosure. The web of material has a first transverse edge and a second transverse edge. The first transverse edge has a lip thereon and the second transverse edge has a plurality of radially inwardly directed lip engaging members thereon to permit size adjustment of the clip device with respect to the first and second conduits.

### FIELD OF THE INVENTION

1. Background of the Invention

This invention relates to adjustable clamps and more particularly to clamp devices for attaching a small diameter line to one or more larger diameter lines, conduits or pipes in close proximity thereto.

2. Prior Art

Fluid containing lines are used everywhere for conduits in residential and industrial installations. Adjacent lines or conduits are often of different diameters from one another. Adjacent lines, for example those utilized in refrigeration systems connecting a condensing unit and an evaporator coil may run side by side. These lines, however, may vibrate due to their internal pressure, fluid flow or connectivity to a pump or motor source. Securement of these lines is often necessary after those lines have been installed. There is a need, therefore, for clamping devices which are openable to receive any of a plurality of diameter pipes, lines or conduits, and which clamps may be adjustably tightened and then secured to a frame or building support.

Universal adaptability and a wide range of adjustability is necessary when securing these lines or conduits together and to their surroundings.

It is therefore an object of the present invention to overcome the disadvantages of the prior art.

It is yet a further object of the present invention to provide a clamping arrangement which is adjustable to provide securement between conduits or lines of differing diameters and of different materials to eliminate corrosion therebetween.

It is still a further object of the present invention to provide a clamping arrangement for multiple conduits as well as for adjacent electrical wiring securement.

It is still yet a further object of the present invention to provide a clamping arrangement which will hold a pair of lines touchingly adjacent to one another for ease of installation and securement, while still providing resistance to corrosion and relative movement therebetween.

### BRIEF SUMMARY OF THE INVENTION

The present invention relates to an adjustable clip or fastener device for securing together a plurality of generally parallel conduits of different diameters and material, to prevent them from interfering with and damaging one another. The clip of the present invention in a first embodiment comprises a generally cylindrically shaped web of material preferably formed from a sheet of flat metallic stock and rolled or formed into that generally cylindrical shape. The web of material has a first transverse edge extending generally longitudinally with respect to the generally cylindrical shape, the first transverse edge having an outwardly directed reverse lip thereon. The reverse lip of the first transverse edge extends generally tangentially to the generally annular periphery of the device. The reverse lip, thus is disposed at an angle of about 15 to 20 degrees with respect to the body of the web.

An elongated, axially disposed enclosure, of “omega” shape in cross-section, is unitarily formed on a generally mid-portion of the web of the device, at a location thereon preferably generally diametrically across from the reverse lip on the first transverse edge. The omega shaped enclosure has a generally longitudinal axis which is parallel with the longitudinal axis of the securement device. The omega shaped enclosure has a peripheral contour which is greater than 180 degrees about its longitudinal axis to insure captivity of a conduit within that omega shaped enclosure. The omega enclosure is arranged to at least partially wrap around (by more than 180 degrees) a small diameter conduit or collection of small conduits.

The second transverse edge of the securement device is disposed radially outwardly of the reverse lip of the first transverse edge. The second transverse edge may in a first preferred embodiment, be comprised of a plurality of spaced-apart, longitudinally aligned, inwardly directed folds arranged to function as a selectable flange to engage the outwardly directed lip on the first transverse edge of the securement device. Once the proper fold is anchored under the lip of the first transverse edge, the remaining distal folds (or flanges if the securement device is made from extruded plastic material) may be cut off as necessary.

In a second preferred embodiment, the second transverse edge may be comprised of a plurality of axially aligned stamped openings, preferably rows of three sided perforations thereon. Those three sided perforations create and define generally radially inwardly directed tangs which provide an array of adjustment securement means for the securement clip. Tangentially directed movement of the second transverse end of the securement clip provides adjustment as to the diameter of the clip as it has been placed about a first or large diameter conduit and a second or smaller diameter conduit which fits within the omega shaped enclosure unitary therewith. The generally radially directed tangs are angled so as to slip behind the reverse lip of the first transverse edge of the securement device to function as a locking and gripping means between the first transverse edge and the second transverse edge.

In operation of the present embodiment, a small diameter conduit such as a liquid line may be disposed within the omega shaped enclosure and the large diameter conduit such as a gas line, may then be disposed within the larger enclosure portion of the securement device. The second transverse edge would then be pulled tightly around the two adjacent conduits to the necessary set of axially aligned tangs would engage behind the reverse lip on the first transverse edge of the securement device. The omega shaped enclosure would pinchably enclose the small diameter conduit around its circumference by greater than 180 degrees, thus maintaining a separation and hence non-wearing relationship between the large diameter conduit and the small diameter conduit.

A short length eyelet may be securely attached to an outer peripheral portion of the web of the securement device for passage of an electrical wire therethrough, or for attachment of the securement device to a stationary building support.

A further embodiment of the securement clip comprises a planar web of flexible material shaped into a generally T-shaped configuration. The T-shaped configuration has a first transverse edge with a reverse lip thereon. The first segment of the transverse edge is formed into a first upper side channel having an adjacent elongated planar backing surface. The elongated planar backing surface extends to a second side thereof, which is formed into a second upper side channel defining a second flip portion of the securement device. The planar web of the securement device extends in a curvilinear matter to form an “omega” shaped conduit enclosure having a longitudinal axis generally in parallel with the longitudinal axis of the securement device. The web on the securement device reverse curves to define a large diameter conduit enclosure having a curvilinear portion extending to a second transverse edge. The second transverse edge in one preferred embodiment has a plurality of axially aligned rows of tangs thereon, which tangs are preferably formed by three sided perforations punched therethrough. Any desired axially aligned row of inwardly directed tangs will, when pulled toward the back portion of the securement device, engage the reversed lip on the first transverse edge of the securement device. In a further preferred embodiment, the tangs are longer than the tangs in the perforation embodiment, but are instead formed from longitudinally spaced apart, longitudinally directed folds, extending the full longitudinal length of the securement device.

Openings disposed through the first and second side portions or channels will permit a fastener to be disposed through those openings of the securement device and onto a stationary wall or joist or the like. Such securement by a fastener through the side portions will also cause the bending of the first and second sides or channel sections closer towards that wall joist or stationary member to further secure a large diameter conduit within the securement device. Use of the attachment fasteners at the first and second side portions or channels of the fastener device will also pinch the omega shaped conduit around its smaller diameter conduit therein.

Thus such a securement device is arranged to be adjusted by attachment fasteners as well as by a second transverse edge portion making engagement between inwardly directed tangs of an outwardly curved second transverse edge against an inwardly curved reverse lip on a first transverse portion of the web.

The invention thus comprises a securement clip device for adjustably securing a first diameter conduit and a second diameter conduit to one another in a parallel, spaced-apart, vibration free relationship. The device comprises a web of material formed into a first diameter conduit enclosing enclosure and a second diameter conduit enclosing enclosure. The web of material has a first transverse edge and a second transverse edge, wherein the first transverse edge has a lip thereon and the second transverse edge has a plurality of lip engaging members thereon to permit size adjustment of the clip device with respect to the first and the second conduits. The lip on the first transverse edge is a reverse flange. The lip on the first transverse edge is arranged generally tangentially thereon with respect to the web. The lip engaging members preferably comprise a plurality of rows of tangs arranged generally radially inwardly. Each of the tangs are preferably a flap formed from a three sided perforation or from a plurality of parallel, spaced apart full length folds of the web. The first diameter conduit enclosing enclosure is preferably of omega shape. The omega shape enclosure preferably wraps around a conduit disposed therein by more than 180 degrees. The web is preferably of generally cylindrical shape in cross-section in a first embodiment thereof.

The web is generally of T-shape in cross-section in a second embodiment thereof, to permit multiple adjustment capabilities on multiple conduits therein. The second transverse edge in the second embodiment, is curved radially away from the first transverse edge to permit manual adjustment therebetween.

### BRIEF DESCRIPTION OF THE DRAWINGS

The objects and advantages of the present invention will become more apparent, when viewed in conjunction with the following drawings in which:

FIG. 1 is an end view of a multi-sized conduit securement device constructed according to the principles of the present invention;

FIG. 2 is a perspective view of the multi-conduit securement device shown in FIG. 1;

FIG. 3 is a side elevational view of a further embodiment of the securement device of the present invention;

FIG. 4 is a view taken along the lines 4-4 of FIG. 3; and

FIG. 5 is a perspective view of the multi-sized conduit securement device shown in FIGS. 3 and 4.

### DETAILED DESCRIPTION OF THE PREFERRED EMBODIMENTS

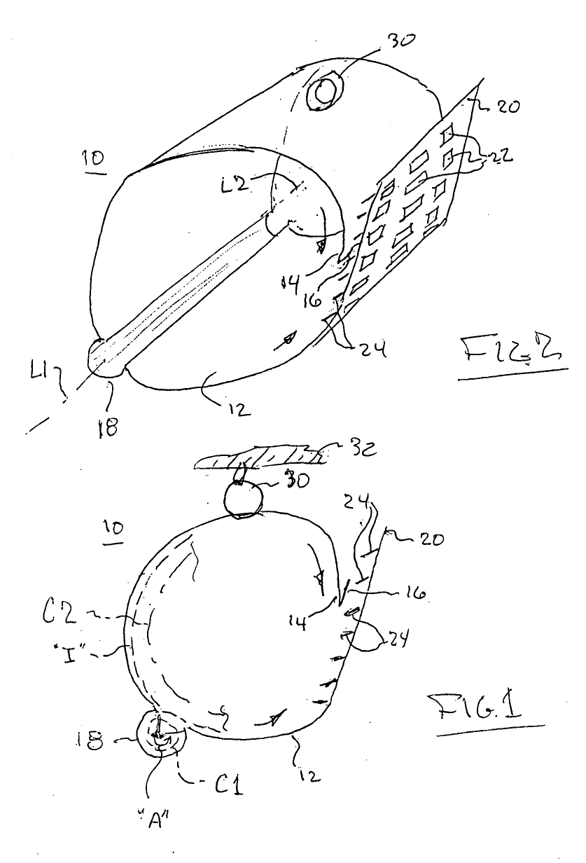

Referring now to the drawings in detail, and particularly to FIG. 1, there is shown the present invention which comprises an adjustable clip or fastener device 10 for securing together a plurality of generally parallel conduits (C1 and C2) of different diameters, to prevent them from interfering with and damaging one another.

The clip device 10 of the present invention in a first embodiment comprises a generally cylindrically shaped web of material 12 preferably formed from a sheet of flat metallic stock and rolled or formed into that generally cylindrical shape, as shown in FIGS. 1 and 2. The web 12 has a first transverse edge 14 extending generally longitudinally with respect to said generally cylindrical shape of the clip device 10, the first transverse edge 14 having a reverse flange or lip 16 thereon. The reverse lip 16 of the first transverse edge 14 extends generally tangentially to the generally annular periphery of the clip device 10, as is represented in FIG. 1. The reverse lip 14, thus is disposed at an angle of about 15 to 20 degrees with respect to the body of the web 12.

At least on elongated, axially disposed enclosure 18, of “omega” shape in cross-section, is unitarily formed on the web 12 of the clip device, 10 at a location thereon preferably generally diametrically across from the reverse lip 16 on the first transverse edge 14, as represented in FIG. 1. The omega shaped enclosure 18 has a generally longitudinal axis L1 which is parallel with the longitudinal axis L2 of the securement clip device 10. The omega shaped enclosure 18 has a peripheral contour which is greater than 180 degrees about its longitudinal axis L1 to insure captivity of a conduit C1 within that omega shaped enclosure 18.

A second transverse edge 20 of the securement clip device 10 is disposed radially outwardly of the reverse lip 16 of the first transverse edge 14, as is shown in FIG. 1. The second transverse edge 20 may in a first preferred embodiment, be comprised of a plurality of full web-width spaced-apart, longitudinally aligned, inwardly directed folds, preferably about ⅛^{th} to ¼^{th} of an inch in height, arranged to function as a selectable flange 24 to engage the outwardly directed lip 16 on the first transverse edge 14 of the securement device 10. Once the proper fold 24, as may be seen in FIG. 1, is anchored under the lip 16 of the first transverse edge 14, the remaining distal folds (or flanges if the securement device is made for example, from an extruded plastic material) may be cut off as necessary.

A second preferred embodiment of the present invention may comprise the second transverse edge 20 having a plurality of axially aligned stamped openings 22, preferably rows of three sided perforations thereon. Those three sided openings 22 create and define generally radially inwardly directed flaps or tangs 24 which provide an array of adjustment securement means for the securement clip device 10. Tangentially directed movement of the second transverse end 20 of the securement clip device 10 permits adjustment as to the diameter of the clip device 10 as it has been placed about a first or large diameter conduit C2 and also about a second or smaller diameter conduit C1 which fits within the omega shaped enclosure 18 unitary therewith. The generally radially directed tangs 24 are angled so as to slip radially behind the reverse lip 16 of the first transverse edge 14 of the securement clip device 10 to function as a locking and gripping means between the first transverse edge 14 and the second transverse edge 20.

In operation of the present embodiment, a small diameter conduit C1 such as a liquid line may be disposed within the omega shaped enclosure 18 and the large diameter conduit C2 such as a gas line, may then be disposed within the larger enclosure portion of the securement clip device 10, as represented in FIG. 1. The second transverse edge 20 would then be pulled tightly around the two adjacent conduits C1 and C2 to engage the necessary set of axially aligned row of tangs 24 would engage behind the reverse lip 16 on the first transverse edge 14 of the securement clip device 10. The omega shaped enclosure 18 would pinchably enclose the small diameter conduit C1 around its circumference by greater than 180 degrees, (the angle A being greater than 180 degrees) thus maintaining a separation and hence non-wearing relationship between the large diameter conduit C2 and the small diameter conduit C1. A layer of insulation “I”, such as a rubberized tape or silicon painted or sprayed on the inner side of the device 10 as represented in FIG. 1, may be utilized to minimize Galvanic corrosion between dissimilar metals.

A short length eyelet 30 may be securely attached to an outer peripheral portion of the web 12 of the securement clip device 10 for passage of an electrical wire therethrough, or for attachment of the securement device 10 to a stationary building support 32.

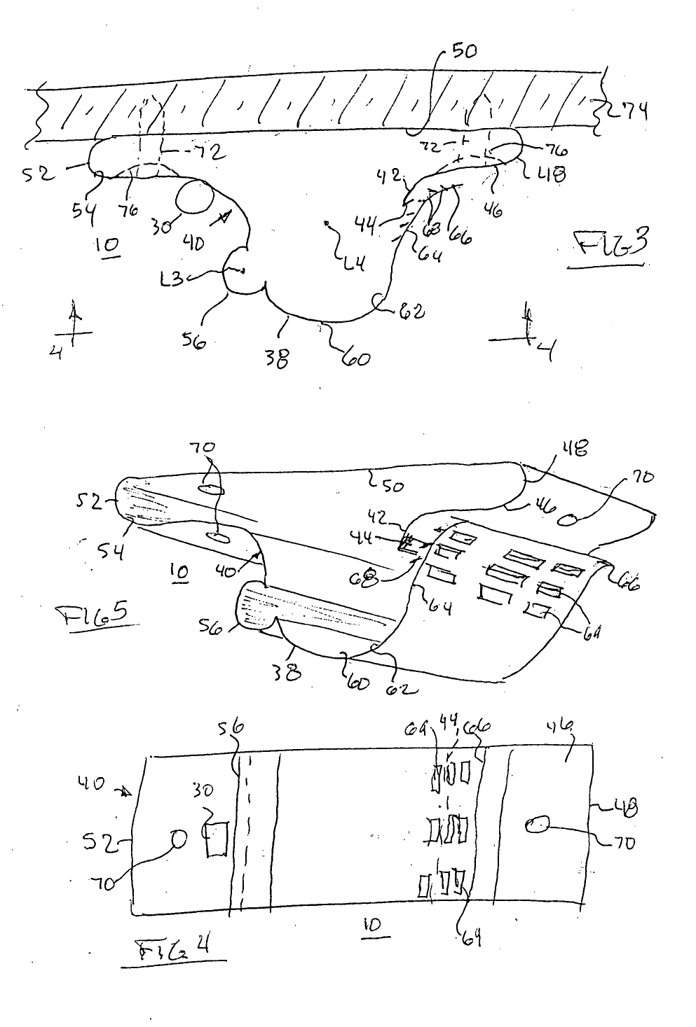

A further embodiment of the securement clip 10 comprises a planar web 38 of flexible material shaped into a generally T-shaped configured clip 40, as may be seen most clearly in FIG. 3. The T-shaped clip 40 has a first transverse edge 42 with a reverse flange or lip 44 formed thereon. The first segment 46 of the web 38 adjacent the first transverse edge 42 is formed into a first upper side channel 48 having an adjacent elongated planar backing surface 50. The elongated planar backing surface 50 extends to a second side 52 thereof, which is formed into a second upper side channel 54 defining a second flip portion of the securement clip device 10. The planar web 38 of the securement device 10 extends in a curvilinear manner to form an “omega” shaped conduit enclosure 56 having a longitudinal axis L3 generally in parallel with the centrally disposed longitudinal axis L4 of the securement clip device 10, as may be seen in FIG. 5. It is to be noted that the centrally disposed longitudinal axis L4 is displaceable as the device is adjusted about a conduit therein (not shown for clarity). The web 38 on the securement device 10 reverse curves (at #60) to define a large diameter conduit enclosure 62 having a curvilinear portion 64 extending to a second transverse edge 66. The second transverse edge 66 may have in one preferred embodiment, a plurality of axially aligned rows of tangs 68 thereon, which are preferably formed by three sided perforations 69 punched therethrough, as may be seen in FIGS. 5 and 6. ThoseAny desired axially aligned row of inwardly directed tangs 68 will, when pulled toward the back portion of the securement device 10, engage the reversed lip 44 on the first transverse edge 42 of the securement device 10.

An arrangement of openings 70 disposed through the first and second side portions or channels 52 and 48 will permit a fastener 72 to be disposed through those openings 70 of the securement device 10 and onto a stationary wall or joist 74 or the like, as represented in FIG. 3. Such securement by a fastener 72 through the side portions 52 and 48 will also cause the bending of the first and second sides or channel sections 52 and 48 closer towards that wall joist or stationary member 74, as represented by dashed lines 76 in FIG. 3, to further secure a large diameter conduit 62 within the securement device 10. Use of the attachment fasteners 72 at the first and second side portions or channels 52 and 48 of the fastener device 10 will also pinch the omega shaped conduit 56 around its smaller diameter conduit therein.

Thus such a securement device 10 is arranged to be adjusted by attachment fasteners 72 as well as by a second transverse edge portion 66 making engagement between inwardly directed tangs 68 of an outwardly curved second transverse edge 68 against an inwardly curved reverse lip 44 on a first transverse portion 42 of the web 38.

1. A securement clip device for adjustably securing a first diameter conduit and a second diameter conduit to one another in a parallel, spaced-apart, vibration free relationship comprising:
a web of material formed into a first diameter conduit enclosing enclosure and a second diameter conduit enclosing enclosure; said web of material having a first transverse edge and a second transverse edge, wherein said first transverse edge has a lip thereon and said second edge has a plurality of lip engaging members thereon to permit size adjustment of said clip device with respect to said first and second conduits.

2. The securement clip device as recited in claim 1, wherein said lip on said first transverse edge is a reverse flange.

3. The securement clip device as recited in claim 2, wherein said lip on said first transverse edge is arranged tangentially thereon with respect to said web.

4. The securement clip device as recited in claim 3, wherein said lip engaging members on said second edge comprise a plurality of parallel rows of folds arranged generally radially inwardly.

5. The securement clip device as recited in claim 3, wherein said lip engaging members on said second edge comprise a plurality of rows of tangs arranged generally radially inwardly.

6. The securement clip device as recited in claim 5, wherein each of said tangs are a flap formed from a three sided perforation.

7. The securement clip device as recited in claim 1, wherein said first diameter conduit enclosing enclosure is of omega shape.

8. The securement clip device as recited in claim 7, wherein said omega shape enclosure wraps around a conduit disposed therein by more than 180 degrees.

9. The securement clip device as recited in claim 1, wherein said web of material has a layer of insulation material arranged on an inner side thereof.

10. The securement clip device as recited in claim 1, wherein said web is of generally cylindrical shape in cross-section.

11. The securement clip device as recited in claim 1, wherein said web is generally of T-shape in cross section, to permit multiple adjustment capabilities on multiple conduits therein.

12. The securement clip device as recited in claim 11, wherein said second transverse edge is curved radially away from said first transverse edge to permit manual adjustment therebetween.

13. The securement clip device as recited in claim 4, wherein said folds extend across the full width of said securement device.

14. The securement clip device as recited in claim 13, wherein said fold has a height of about ⅛^{th} to ¼^{th} inch.
